(19) United States
(12) Patent Application Publication
(10) Pub. No.: US 2026/0330724 A1
(43) Pub. Date: Oct. 22, 2026

(54) IMAGE PROCESSING APPARATUS AND IMAGE PROCESSING METHOD

(71) Applicant: CANON KABUSHIKI KAISHA, Tokyo (JP)

(72) Inventor: HIROSHI KANEKO, Kanagawa (JP)

(21) Appl. No.: 19/529,225

(22) Filed: Feb. 4, 2026

(30) Foreign Application Priority Data
Feb. 10, 2025 (JP) 2025-020245

(51) Int. Cl. G06T 11/60; G06F 40/40; G06T 5/50; G06T 5/60; G06V 10/25; G06V 40/16

(52) U.S. Cl. CPC G06T 11/60; G06F 40/40; G06T 5/50; G06T 5/60; G06V 10/25; G06V 40/168; G06T 2207/20084; G06T 2207/20212; G06T 2207/30201

(57) ABSTRACT

An image processing apparatus generates first prompt information in which a feature of an original image is described in text data, determines a specific object from the original image based on the first prompt information, generates an image of the specific object from the original image, and generates second prompt information in which a feature of an image of a non-specific object acquired by excluding a region of the specific object from the original image is described in text data.

### BACKGROUND

### Field of the Technology

The present disclosure relates to a technical field of storing a prompt in which a feature of an image is described in text data and restoring the image from the prompt.

### Description of the Related Art

There is known a method of generating an image by inputting text data called a prompt to generative Artificial Intelligence (AI). To reduce the data amount of an image, there is also known a method of generating a prompt from an image, storing the prompt, and then restoring the image by inputting the prompt to generative AI. When generative AI generates an image from a prompt, the contents of the prompt contribute to improvement of the reproducibility of a restored image generated by the generative AI.

Japanese Patent Laid-Open No. 2022-18997 describes a method of outputting, together with an image, a result of performing image recognition processing by a learned Deep Neural Network (DNN) by receiving an image as an input.

In Japanese Patent Laid-Open No. 2022-18997, when outputting both image data and an image recognition result, a data amount cannot be reduced. When outputting only the image recognition result, even if the image is restored by inputting the image recognition result as a prompt to generative AI, only a recognized object is reproduced, and the reproducibility of the image is low.

### SUMMARY

The present disclosure has been made in consideration of the aforementioned problems, and provides technical advantages in reducing the data amount of an image by storing a prompt in which a feature of the image is described in text data and improving the reproducibility of the image when restoring the image from the prompt.

In order to solve the aforementioned problems, the present disclosure is directed to an image processing apparatus comprising: a first prompt generation unit that generates first prompt information in which a feature of an original image is described in text data; a specific object determination unit that determines a specific object from the original image based on the first prompt information; a first image generation unit that generates an image of the specific object from the original image; and a second prompt generation unit that generates second prompt information in which a feature of an image of a non-specific object acquired by excluding a region of the specific object from the original image is described in text data.

According to the present disclosure, it is possible to reduce the data amount of an image by storing a prompt in which a feature of the image is described in text data and improve the reproducibility of the image when restoring the image from the prompt.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram exemplifying an apparatus configuration according to a first embodiment;

FIG. 2 is a flowchart exemplifying image processing according to the first embodiment;

FIG. 3 is a view illustrating a method of generating a specific object image and a non-specific object prompt according to the first embodiment;

FIGS. 4A to 4C are views respectively exemplifying an image prompt, specific object information, and a non-specific object prompt generated according to the first embodiment;

FIG. 5 is a flowchart exemplifying specific object determination processing according to the first embodiment;

FIG. 6 is a table exemplifying a result during the specific object determination processing according to the first embodiment;

FIG. 7 is a view illustrating an image restoration method according to the first embodiment;

FIGS. 8A and 8B are flowcharts exemplifying specific object determination processing according to a second embodiment;

FIG. 9 is a view illustrating a method of generating a specific object image and a non-specific object prompt according to the second embodiment;

FIGS. 10A to 10D are views respectively exemplifying an image prompt, specific object information, a non-specific object prompt, and a result during the specific object determination processing according to the second embodiment;

FIG. 11 is a block diagram exemplifying an apparatus configuration according to a third embodiment;

FIG. 12 is a flowchart exemplifying image processing according to the third embodiment;

FIG. 13 is a view exemplifying a method of generating a main object image, a specific object image, and a non-specific object prompt according to the third embodiment;

FIGS. 14A to 14D are views respectively exemplifying an image prompt, specific object information, a non-specific object prompt, and a result during specific object determination processing according to the third embodiment; and

FIG. 15 is a view illustrating an image restoration method according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

The present embodiment will describe an example in which a computer apparatus operates as an image processing apparatus to determine a specific object in accordance with the contents of prompt information generated from an original image, store the specific object as an image intact, and store objects other than the specific object as prompt information, thereby improving the reproducibility of the image while reducing the data amount of the image.

### First Embodiment

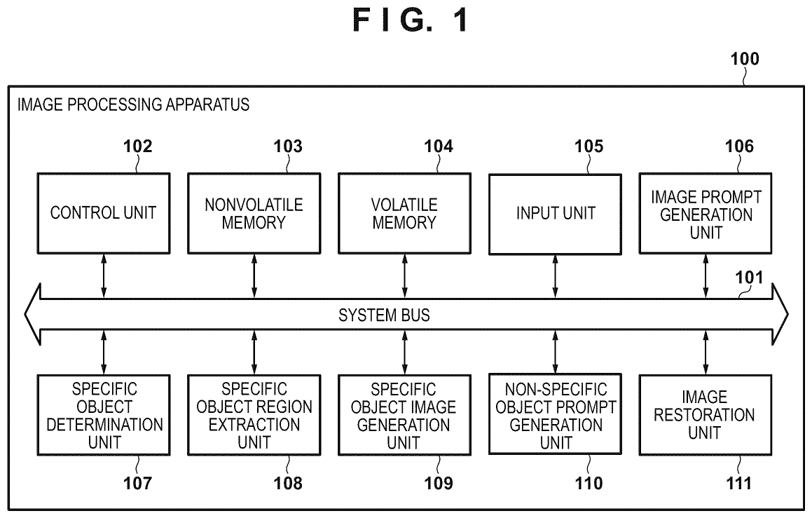

The first embodiment will be described first with reference to FIGS. 1 to 7.

FIG. 1 is a block diagram exemplifying the functional configuration of an image processing apparatus according to the first embodiment.

An image processing apparatus 100 includes a control unit 102, a nonvolatile memory 103, a volatile memory 104, an input unit 105, an image prompt generation unit 106, a specific object determination unit 107, a specific object region extraction unit 108, a specific object image generation unit 109, a non-specific object prompt generation unit 110, and an image restoration unit 111. The respective components of the image processing apparatus 100 are connected so as to be able to transmit/receive data via a system bus 101.

The image processing apparatus 100 is, for example, a general-purpose computer such as a smartphone, a personal computer (PC), or a tablet computer, or a dedicated computer such as a server computer.

The function of the image processing apparatus 100 according to the present embodiment is implemented by the hardware shown in FIG. 1 and/or a software program executed by the control unit 102.

The control unit 102 is an arithmetic processor such as a CPU or an MPU that generally controls the entire image processing apparatus 100, and executes programs stored in the nonvolatile memory 103, thereby implementing image processing to be described later. Note that instead of controlling the entire apparatus by the control unit 102, a plurality of hardware components may control the entire apparatus by sharing processing.

The nonvolatile memory 103 is a Read Only Memory (ROM) or a flash memory from/in which data can be removed/written. The nonvolatile memory 103 stores constants for the operation of the control unit 102, programs, and the like. In the present embodiment, the programs are those for executing image processing to be described later. Note that the programs for the control unit 102 to operate are not limited to being stored in the nonvolatile memory 103 and may be stored in an auxiliary storage device such as a hard disk. The nonvolatile memory 103 stores an original image as a processing target of the present embodiment. Note that an original image is stored in the nonvolatile memory 103 in the present embodiment, but the present disclosure is not limited to this, and an original image may be input from an external apparatus on a network via a communication interface (not shown). When an original image is externally input, the input image is stored in the volatile memory 104.

The volatile memory 104 is a Random Access Memory (RAM) that temporarily stores a program read out from the nonvolatile memory 103, constants and variables for executing the program, and the like. The volatile memory 104 is used as a work memory by the control unit 102 to execute the program.

The input unit 105 is an input device that accepts a user operation, and includes physical operation buttons and a touch panel. Note that the touch panel is an input device configured to, for example, output coordinate information according to a touch position on a two-dimensionally constructed input part. The input unit 105 generates a control signal according to a user operation and supplies it to the control unit 102, and the control unit 102 performs control according to the control signal.

The image prompt generation unit 106 generates, by inference processing using a learned model by receiving an original image as an input, image prompt information in which features of objects included in the original image are described in text data, and stores the information in the nonvolatile memory 103. The image prompt information is stored in the nonvolatile memory 103 and the original image is stored in the nonvolatile memory 103 in the present embodiment. However, the present disclosure is not limited to this, and the image prompt information may be output to an external apparatus on a network via a communication interface (not shown) and stored. Note that image prompt information may be generated using another image processing technique such as pattern matching instead of the inference processing using the learned model.

The specific object determination unit 107 extracts subjects as pieces of object information and modifiers for explaining the object information from the image prompt information. Furthermore, the specific object determination unit 107 determines, for each subject, in accordance with the contents and number of modifiers, whether the subject is the specific object, and outputs information of the determined specific object.

The specific object region extraction unit 108 extracts a region of the specific object from the original image.

The specific object image generation unit 109 performs transparency processing for a region other than the specific object region in the original image, generates a specific object image while leaving image information of the region of the specific object, and stores the generated image in the nonvolatile memory 103. The specific object image is an image having the same size as that of the original image.

The non-specific object prompt generation unit 110 deletes information concerning the subject determined as the specific object from the image prompt information, generates non-specific object prompt information in which features of objects other than the specific object among the objects included in the original image are described in text data, and stores the generated information in the nonvolatile memory 103.

The image restoration unit 111 generates a non-specific object restored image having the same size as that of the original image by inference processing using a learned model by receiving the non-specific object prompt information as an input. Then, the image restoration unit 111 generates a restored image by compositing the specific object image and the non-specific object restored image, and stores the restored image in the nonvolatile memory 103. Note that in the present embodiment, the image restoration unit 111 is included in the image processing apparatus 100, but may be an image restoration apparatus separated from the image processing apparatus 100, a recording apparatus that stores a restored image, or the like.

The learned model according to the present embodiment is formed by a neural network, and the inference processing according to the present embodiment can be executed by a Graphics Processing Unit (GPU) or a Digital Signal Processor (DSP). The GPU or DSP is a processor capable of performing an enormous amount of product-sum operations, bias addition operations, and nonlinear processing, and has arithmetic processing capability of performing a matrix operation of a neural network and the like within a short time. Note that in the inference processing, the CPU of the control unit 102 and the GPU or DSP may perform arithmetic processing in cooperation with each other or one of the CPU of the control unit 102 and the GPU or DSP may perform arithmetic processing.

### Image Processing

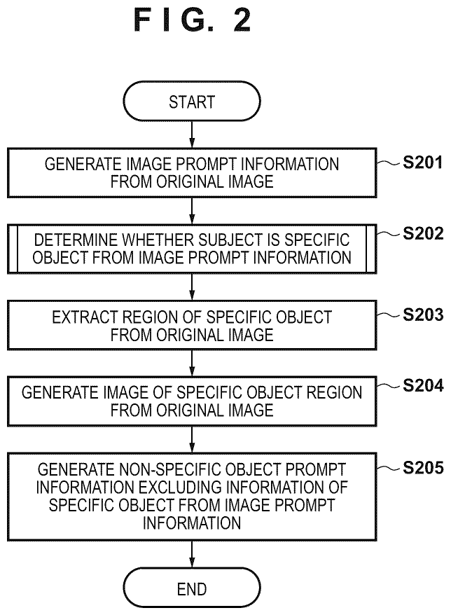

Processing of generating, by the image processing apparatus 100, a specific object image and non-specific object prompt information from an original image will be described next with reference to FIGS. 2 to 4C.

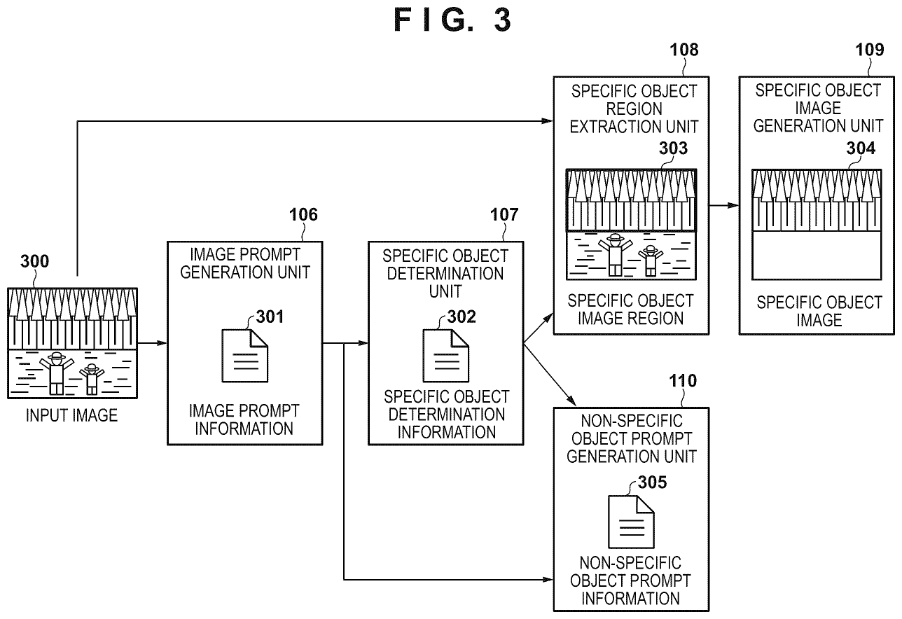

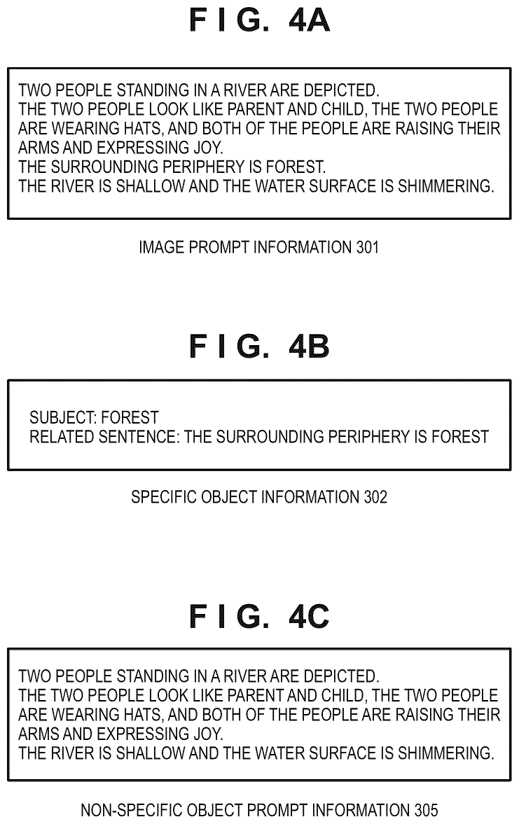

FIG. 2 is a flowchart exemplifying processing of generating a specific object image and non-specific object prompt information from an original image according to the present embodiment. FIG. 3 is a view illustrating a method of generating a specific object image and non-specific object prompt information from an original image according to the present embodiment. FIGS. 4A to 4C are views respectively exemplifying image prompt information, specific object information, and a result during specific object determination processing according to the present embodiment.

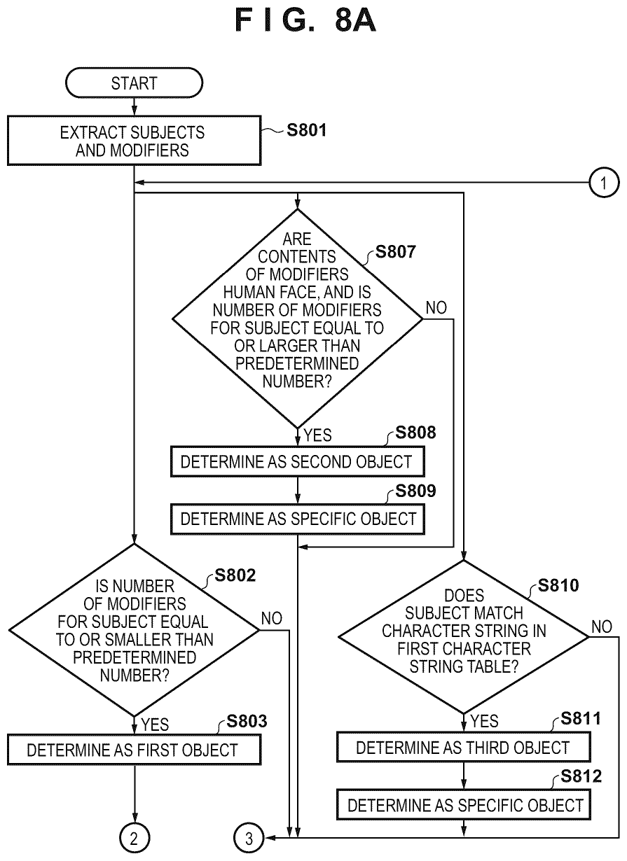

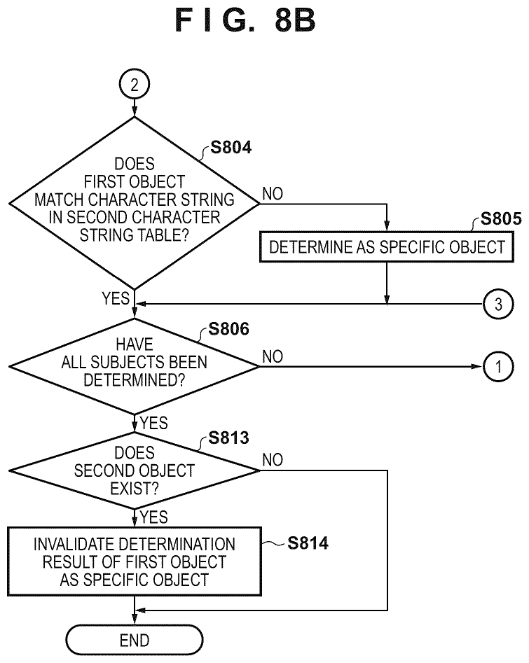

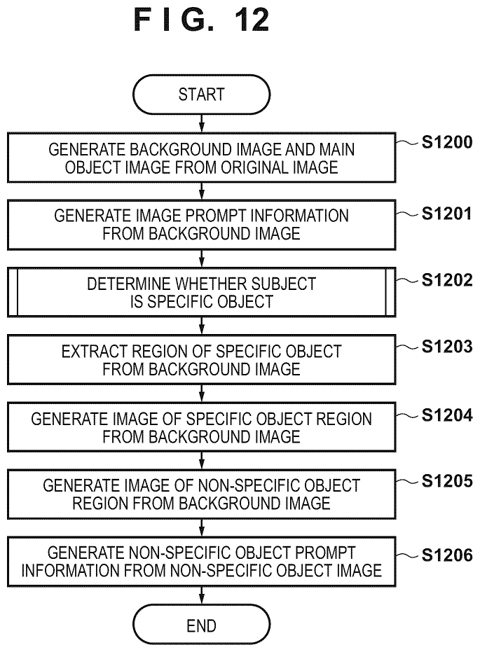

The processing shown in FIG. 2 is implemented when the control unit 102 controls the respective components of the image processing apparatus 100 via the system bus 101 by loading a program stored in the nonvolatile memory 103 into the volatile memory 104 and executing the program. The same applies to FIGS. 8 and 12 to be described later.

In step S201, the image prompt generation unit 106 reads out an original image 300 from the nonvolatile memory 103, and generates, by inference processing using a learned model by receiving the original image as an input, image prompt information 301 in which features of objects included in the original image 300 are described in text data, and the process advances to step S202. FIG. 4A shows the image prompt information 301 according to the present embodiment.

In step S202, the specific object determination unit 107 extracts subjects as pieces of object information and modifiers for explaining the object information from the image prompt information 301, determines, for each subject, in accordance with the contents of the modifiers and the number of modifiers, whether the subject is the specific object, and outputs specific object information 302 concerning the determined specific object. FIG. 4B shows the specific object information 302 according to the present embodiment. The processing of the specific object determination unit 107 will be described later.

In step S203, the specific object region extraction unit 108 extracts a specific object image region 303 as the region of the specific object from the original image, and the process advances to step S204. FIG. 3 shows, by black thick lines, the specific object image region 303 of “forest” as the specific object of the present embodiment.

In step S204, the specific object image generation unit 109 performs transparency processing for a region other than the specific object image region 303 in the original image, generates a specific object image 304 while leaving only image information of the specific object image region 303, and stores it in the nonvolatile memory 103, and the process advances to step S205. FIG. 3 shows the specific object image 304 according to the present embodiment.

In step S205, the non-specific object prompt generation unit 110 generates non-specific object prompt information 305 by deleting information concerning the subject determined as the specific object from the image prompt information, and stores it in the nonvolatile memory 103, and the processing ends. FIG. 4C shows the non-specific object prompt information 305 according to the present embodiment.

### Specific Object Determination Processing

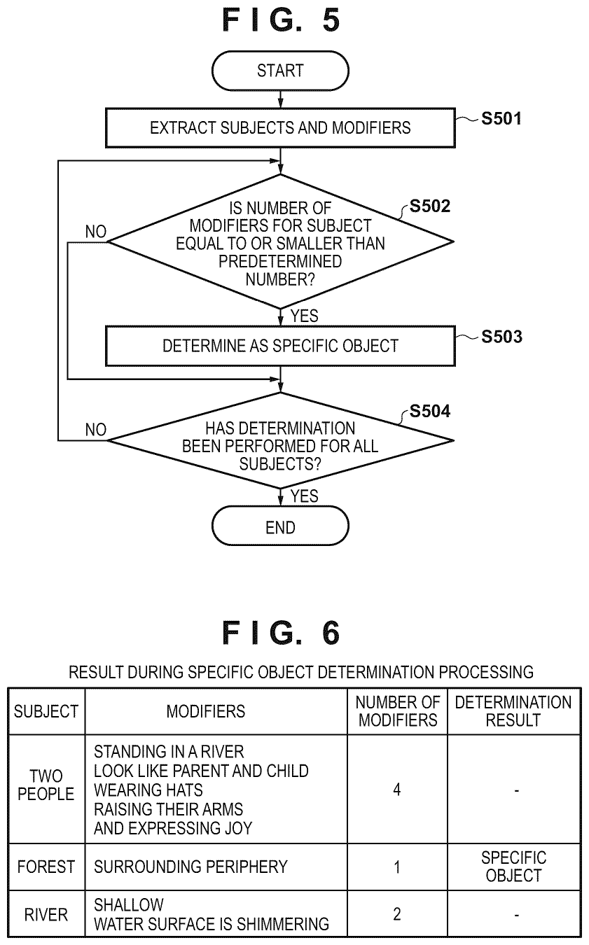

The processing of determining the specific object by the specific object determination unit 107 will be described next with reference to FIG. 5.

Upon receiving the image prompt information 301 generated by the image prompt generation unit 106, the specific object determination unit 107 starts the processing.

In step S501, the specific object determination unit 107 extracts a plurality of subjects as a plurality of pieces of object information and modifiers for explaining each object from the image prompt information 301 by natural language processing, and the process advances to step S502. Note that a method of extracting subjects and modifiers is not limited to natural language processing, and may be implemented using another known technique.

In step S502, the specific object determination unit 107 determines, for each subject extracted in step S501, whether the number of modifiers is equal to or smaller than a predetermined number. When it is determined that the number of modifiers is equal to or smaller than the predetermined number, the process advances to step S503, and when it is determined that the number of modifiers exceeds the predetermined number, the process advances to step S504.

In step S503, the specific object determination unit 107 determines, as the specific object, the subject determined in step S502, and the process advances to step S504.

In step S504, the specific object determination unit 107 determines whether the determination processing of steps S502 and S503 has been executed for all the subjects extracted in step S501. When the determination processing for all the subjects is complete, the processing ends, and when the determination processing for all the subjects is incomplete, the process returns to step S502, and the processes of steps S502 to S504 are repeated until the determination processing for all the subjects is completed.

Upon completion of the processing, the specific object determination unit 107 outputs the specific object information 302 as information of the specific object, and the process advances to step S203.

Next, the processing of outputting, by the specific object determination unit 107, the specific object information 302 from the image prompt information 301 will be described with reference to FIG. 6.

The specific object determination unit 107 extracts subjects, modifiers, and the number of modifiers from the image prompt information 301. FIG. 6 shows the extracted subjects and modifiers. The specific object determination unit 107 extracts subjects “two people”, “forest”, and “river”, and extracts modifiers and the number of modifiers for each subject, as shown in FIG. 6.

Next, the specific object determination unit 107 determines the specific object based on the extracted subjects and the number of modifiers. In the present embodiment, the predetermined number of modifiers is set to 1 and each subject is determined.

The subject “two people” is not determined as the specific object since the number of modifiers is four which exceeds the predetermined number.

The subject “forest” is determined as the specific object since the number of modifiers is one which is equal to or smaller than the predetermined number.

The subject “river” is not determined as the specific object since the number of modifiers is two which exceeds the predetermined number.

Next, the specific object determination unit 107 outputs the specific object information 302 as information concerning “forest” determined as the specific object, and then ends the processing.

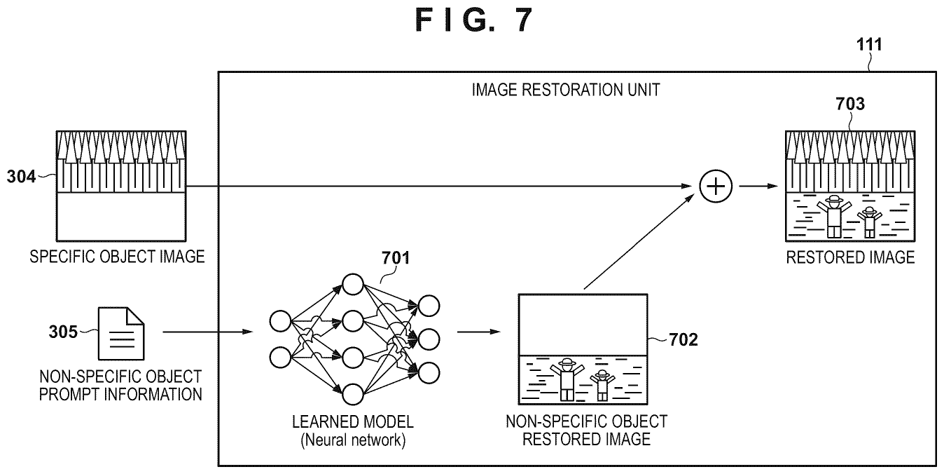

Next, a method of restoring an image from the specific object image 304 and the non-specific object prompt information 305 according to the present embodiment will be described next with reference to FIG. 7.

The image restoration unit 111 generates a non-specific object restored image 702 by inference processing using a learned model 701 by receiving the non-specific object prompt information 305 as an input. In the present embodiment, the non-specific object prompt information 305 is input to a learned Visual Language Model (VLM) to generate noise data, and a reverse diffusion process is performed by a learned diffusion model by receiving the generated noise data as an input, thereby generating an image in which a non-specific object is restored. This is an example of Text to Image generation, but the present disclosure is not limited to this.

Next, the image restoration unit 111 composites the non-specific object restored image 702 with the specific object image 304, thereby generating a restored image 703.

As described above, according to the first embodiment, a specific object is determined in accordance with the contents of prompt information generated from an original image, an image is output for the specific object, and a prompt is generated for a non-specific object other than the specific object, thereby making it possible to improve the reproducibility of the image while reducing the data amount of the image.

### Second Embodiment

The second embodiment will be described next with reference to FIGS. 2 and 8 to 10D.

An apparatus configuration according to the second embodiment is the same as in FIG. 1 of the first embodiment. The second embodiment is different from the first embodiment in that processing of determining a specific object based on image prompt information is added. To perform the added processing, a specific object determination unit 107 has a first character string table and a second character string table. The first character string table and the second character string table are stored in a nonvolatile memory 103.

First, processing of generating, by an image processing apparatus 100 of the second embodiment, a specific object image and non-specific object prompt information from an original image will be described with reference to FIGS. 2, 9, and 10A to 10D.

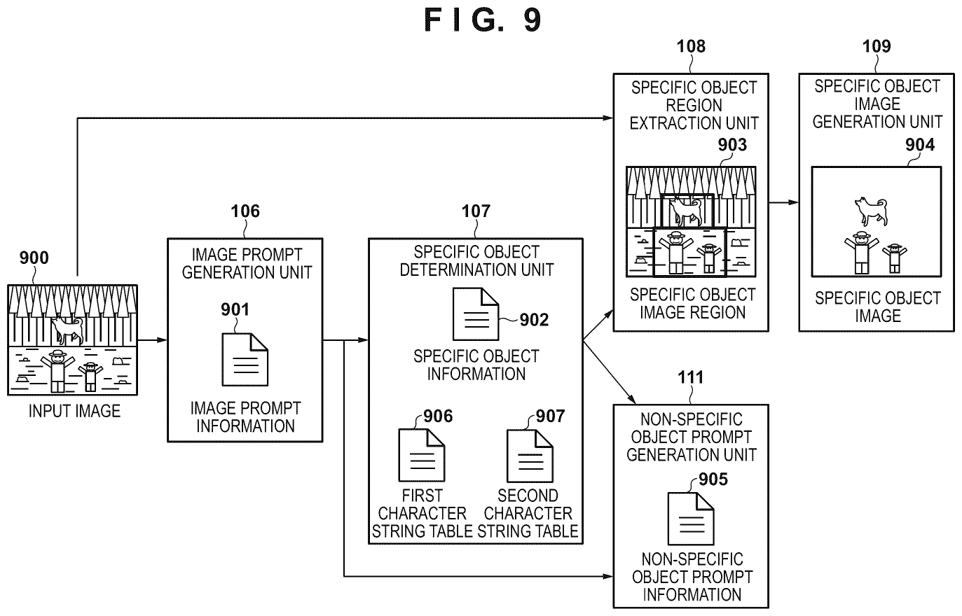

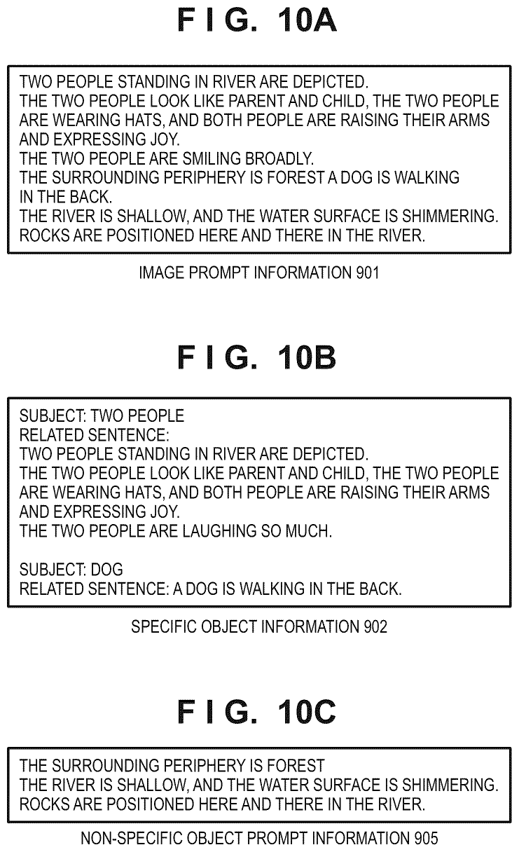

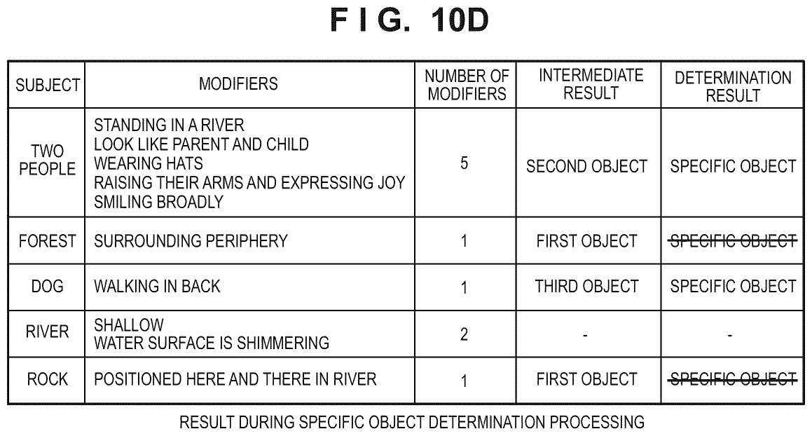

The processing shown in FIG. 2 is as described in the first embodiment. FIG. 9 is a view illustrating a method of generating a specific object image and non-specific object prompt information from an original image according to the second embodiment. FIGS. 10A to 10D respectively exemplify image prompt information, specific object information, non-specific object prompt information, and a result during specific object determination processing according to the second embodiment.

In step S201, an image prompt generation unit 106 reads out an original image 900 from the nonvolatile memory 103, and generates, by inference processing using a learned model by receiving the original image 900 as an input, image prompt information 901 in which features of objects included in the original image 900 are described in text data, and the process advances to step S202. FIG. 10A shows the image prompt information 901 according to the present embodiment.

In step S202, a specific object determination unit 107 extracts subjects as pieces of object information and modifiers for explaining each object from the image prompt information 901, determines, for each subject, in accordance with the contents of the modifiers, the number of modifiers, a first character string table 906, and a second character string table 907, whether the subject is the specific object, and outputs specific object information 902 concerning the determined specific object. FIG. 10B shows the specific object information 902 according to the present embodiment. The first character string table 906 is a list for designating objects to be stored as images by the user. The second character string table 907 is a list concerning simple objects, and includes, for example, objects with high reproducibility when generating images by inference processing using a learned model, such as an apple and a banana. In the present embodiment, the first character string table 906 stores “dog”, and the second character string table 907 stores “rock”. Note that the first character string table 906 is a list of objects stored as images, the second character string table 907 is a list of objects which are not stored as images and for which a prompt is generated, and the contents of the lists are not particularly limited. In the present embodiment, when the user inputs a character string from an input unit 105 and performs a predetermined operation, a control unit 102 stores the character string in each of the first character string table 906 and the second character string table 907. However, the character string may be stored in advance in the nonvolatile memory 103, read out at the start of the processing, and used, and the input method is not particularly limited.

In step S203, a specific object region extraction unit 108 extracts a specific object image region 903 as a region of the specific object from the original image 900, and the process advances to step S204. FIG. 9 shows, by black thick lines, the specific object image regions 903 of “two people” and “dog” as the specific objects of the present embodiment.

In step S204, a specific object image generation unit 109 performs transparency processing for a region other than the specific object image regions 903 in the original image 900, generates a specific object image 904 while leaving only image information of the specific object image regions 903, and stores it in the nonvolatile memory 103, and the process advances to step S205.

In step S205, a non-specific object prompt generation unit 110 generates non-specific object prompt information 905 as text data acquired by deleting information concerning the subjects determined as the specific objects indicated by the specific object information 902 from the image prompt information 901 and excluding the pieces of information of the specific objects from the information of the original image, and stores it in the nonvolatile memory 103, and the processing ends. FIG. 10C shows the non-specific object prompt information 905 according to the present embodiment.

A method of determining a specific object by the specific object determination unit 107 of the second embodiment in step S202 of FIG. 2 will be described next with reference to FIGS. 8 and 10D.

FIGS. 8A and 8B are flowcharts exemplifying specific object determination processing according to the present embodiment.

Upon receiving the image prompt information 901 generated by the image prompt generation unit 106, the specific object determination unit 107 starts the processing shown in FIGS. 8A and 8B.

In step S801, the specific object determination unit 107 extracts a plurality of subjects as a plurality of pieces of object information and modifiers for explaining each object from the image prompt information 901, and the process advances to step S802.

For each subject extracted in step S801, the specific object determination unit 107 executes processing of steps S802 to S805 of first object determination, steps S807 to S809 of second object determination, and steps S810 to S812 of third object determination.

In step S802, the specific object determination unit 107 determines whether the subject has modifiers the number of which is equal to or smaller than a predetermined number. When it is determined that the number of modifiers is equal to or smaller than the predetermined number, the process advances to step S803. When it is determined that the number of modifiers exceeds the predetermined number, the process advances to step S806.

In step S803, the specific object determination unit 107 determines, as a first object, the subject determined in step S802, and the process advances to step S804.

In step S804, the specific object determination unit 107 compares the first object with the character string in the second character string table 907. When they match each other, the process advances to step S806, and when they do not match each other, the process advances to step S805.

In step S805, the specific object determination unit 107 determines the first object as the specific object, and the process advances to step S806.

In step S807, the specific object determination unit 107 determines whether the contents of the modifiers concerning the subject extracted in step S801 can be determined to indicate a person face, and the subject has modifiers the number of which is equal to or larger than the predetermined number. When the determination conditions are satisfied, the process advances to step S808, and when the determination conditions are not satisfied, the process advances to step S806. In the present embodiment, the predetermined number is set to two.

In step S808, the specific object determination unit 107 determines, as a second object, the subject determined in step S807, and the process advances to step S809.

In step S809, the specific object determination unit 107 determines the second object as the specific object, and the process advances to step S806.

In step S810, the specific object determination unit 107 compares the subject extracted in step S801 with the character string in the first character string table 906. When they match each other, the process advances to step S811, and when they do not match each other, the process advances to step S806.

In step S811, the specific object determination unit 107 determines, as a third object, the subject that has been compared and matched in step S810, and the process advances to step S812.

In step S812, the specific object determination unit 107 determines the third object as the specific object, and the process advances to step S806.

When the specific object determination unit 107 has completed the determination, in step S806, for all the plurality of subjects extracted in step S801, the process advances to step S813. When determination of all the subjects is incomplete, the process returns to steps S802, S807, and S810, and the processes of steps S802 to S812 are repeated until determination of all the subjects is completed.

In step S813, the specific object determination unit 107 determines whether there exists the subject determined as the second object. When there exists such subject, the process advances to step S814. When there is no such subject, the processing ends, and the specific object information 902 is output.

In step S814, the specific object determination unit 107 invalidates the determination result of the first object determined as the specific object, ends the processing, and outputs the specific object information 902.

Next, the processing of outputting, by the specific object determination unit 107, the specific object information 902 from the image prompt information 901 will be described with reference to FIG. 10D.

The specific object determination unit 107 extracts subjects, modifiers, and the number of modifiers from the image prompt information 901. FIG. 10D shows the extracted subjects and modifiers. The specific object determination unit 107 extracts subjects “two people”, “forest”, “river”, “dog”, and “rock”, and extracts modifiers and the number of modifiers for each subject, as shown in FIG. 10D.

Next, the specific object determination unit 107 determines the first to third objects based on the extracted subjects and the numbers of modifiers, and determines specific objects. In the present embodiment, the predetermined number of modifiers is set to one, thereby determining the subjects.

The subject “two people” is not determined as the first object since the number of modifiers is five which exceeds the predetermined number. Next, since the subject “two people” is determined as person faces based on the contents of a modifier “smiling broadly”, and the number of modifiers is two or more, the subject is determined as the second object and determined as the specific object. Since the subject does not match any character string in the first character string table 906, it is not determined as the third object.

The subject “forest” is determined as the first object since the number of modifiers is one which is equal to or smaller than the predetermined number, and is determined as the specific object since the subject does not match any character string in the second character string table 907. Since there is no modifier with which the contents of a person face can be recognized and the subject does not match any character string in the first character string table 906, the subject is determined as neither the second object nor the third object.

The subject “dog” is determined as the first object since the number of modifiers is one which is equal to or smaller than the predetermined number, and is determined as the specific object since the subject does not match any character string in the second character string table 907. Since there is no modifier for recognizing a person face, the subject is not determined as the second object. Next, since the subject matches “dog” in the first character string table 906, it is determined as the third object, and determined as the specific object. In the present embodiment, when the subject is determined as both the first object and the third object, the subject is determined as the third object.

The subject “river” is determined as none of the first to third objects since the number of modifiers is two which exceeds the predetermined number, there is no modifier with which the contents of a person face can be determined, and the subject does not match any character string in the first character string table 906.

The subject “rock” is determined as the first object since the number of modifiers is one which is equal to or smaller than the predetermined number, and is not determined as the specific object since the subject matches the character string in the second character string table 907. Since there is no modifier with which the contents of a person face can be determined, and the subject does not match any character string in the first character string table 906, the subject is determined as neither the second object nor the third object.

Next, since there is the subject “two people” determined as the second object, the result of determining, as the specific object, “forest” which is the first object is invalidated, the specific object information 902 as information indicating that the remaining subjects “two people” and “dog” are the specific objects is output, and then the specific object determination unit 107 ends the processing.

Next, an image restoration unit 111 generates a restored image using the specific object image 904 and the non-specific object prompt information 905. Restored image generation processing is as described in the first embodiment.

As described above, according to the second embodiment, when an original image includes a person face whose reproducibility should be prioritized, an image associated with the person is stored, and a prompt is generated with respect to an image other than the image associated with the person, thereby making it possible to improve the reproducibility of the image while reducing the data amount of the image.

In addition, by determining an object designated by the user and storing an associated image, it is possible to generate an image in consideration of the user's intention while reducing the data amount of the image.

### Third Embodiment

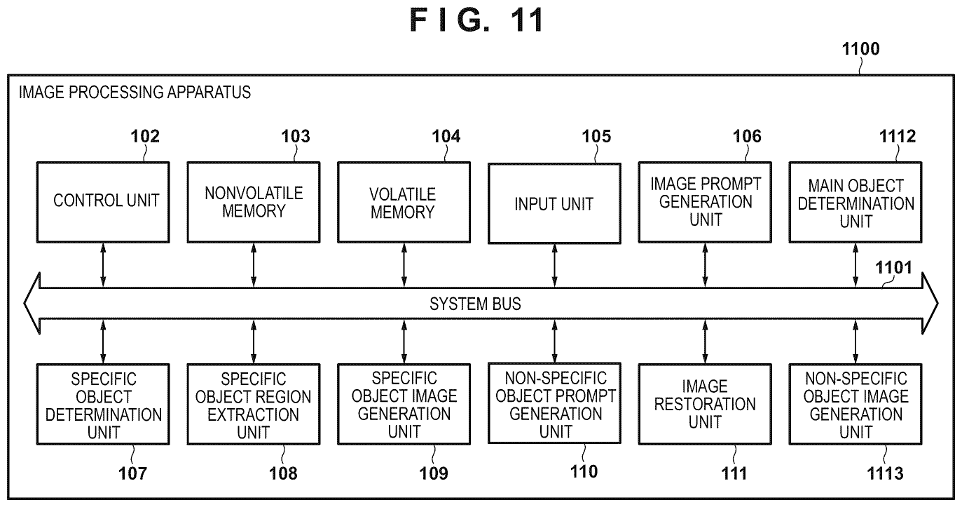

The third embodiment will be described next with reference to FIGS. 11 to 15.

The third embodiment is different from the second embodiment in that an original image is separated into a main object image and a background image in advance. The third embodiment is also different from the second embodiment in that non-specific object prompt information is generated from a non-specific object image. Furthermore, the third embodiment is different from the second embodiment in that an image is restored from three images of a main object image, a specific object image, and a non-specific object image.

FIG. 11 is a block diagram exemplifying an apparatus configuration according to the third embodiment.

An image processing apparatus 1100 includes a main object determination unit 1112 and a non-specific object image generation unit 1113 in addition to the image processing apparatus 100 shown in FIG. 1 of the first embodiment. Note that the functions of a control unit 102, a nonvolatile memory 103, a volatile memory 104, an input unit 105, an image prompt generation unit 106, a specific object determination unit 107, a specific object region extraction unit 108, a specific object image generation unit 109, and a non-specific object prompt generation unit 110 are the same as in the first embodiment.

A system bus 1101 is different from that in the first embodiment in that the system bus is additionally connected to the main object determination unit 1112 and the non-specific object image generation unit 1113.

An image restoration unit 111 generates a non-specific object restored image having the same size as that of an original image by inference processing using a learned model by receiving non-specific object prompt information as an input. Furthermore, the image restoration unit 111 generates a restored image by compositing a specific object image, the non-specific object restored image, and a main object image, and stores the generated restored image in the nonvolatile memory 103. The difference from the first embodiment is that a main object image is added to input data and three images are composited.

The main object determination unit 1112 determines a main object from an original image by inference processing using a learned model by receiving the original image as an input, and separates the original image into a main object image and a background image. In addition, the main object determination unit 1112 stores the separated main object image in the nonvolatile memory 103. The main object image and the background image are images having the same size as that of the original image. In the present embodiment, the main object image is stored in the nonvolatile memory 103. However, the present disclosure is not limited to this, and the main object image may be output to an external apparatus on a network via a communication interface (not shown) and stored. The background image is temporarily stored in the volatile memory 104. Note that instead of the inference processing using the learned model, another image processing technique such as pattern matching may be used by the main object determination unit 1112 to determine the main object.

The non-specific object image generation unit 1113 performs transparency processing for image information of a specific object region in the original image, generates a non-specific object image while leaving image information of a region other than the specific object region, and stores the generated image in the volatile memory 104. The non-specific object image is an image having the same size as that of the original image.

Next, processing of generating, by the image processing apparatus 1100, a specific object image and non-specific object prompt information from an original image will be described with reference to FIGS. 12 to 14D.

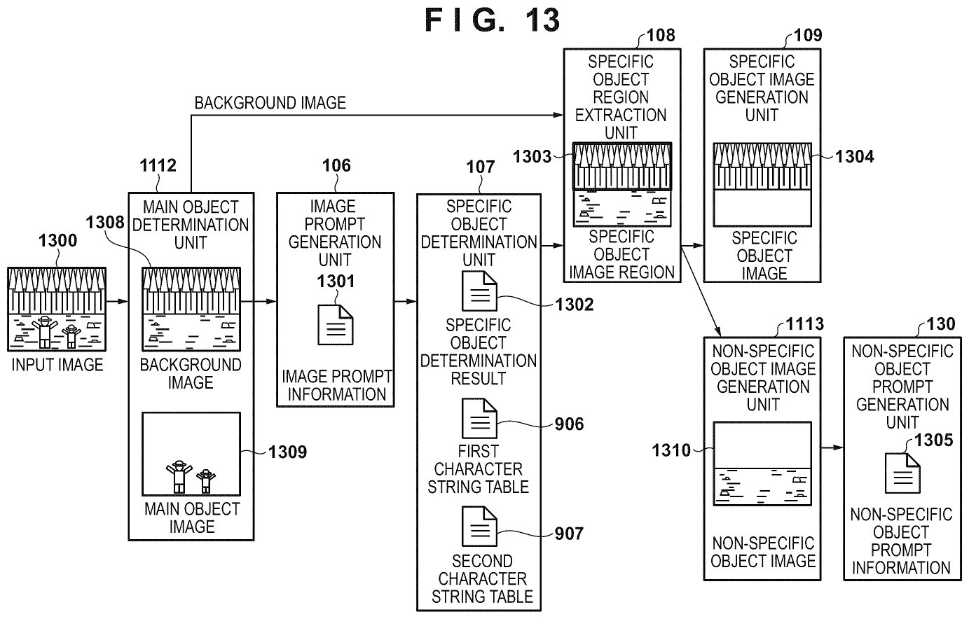

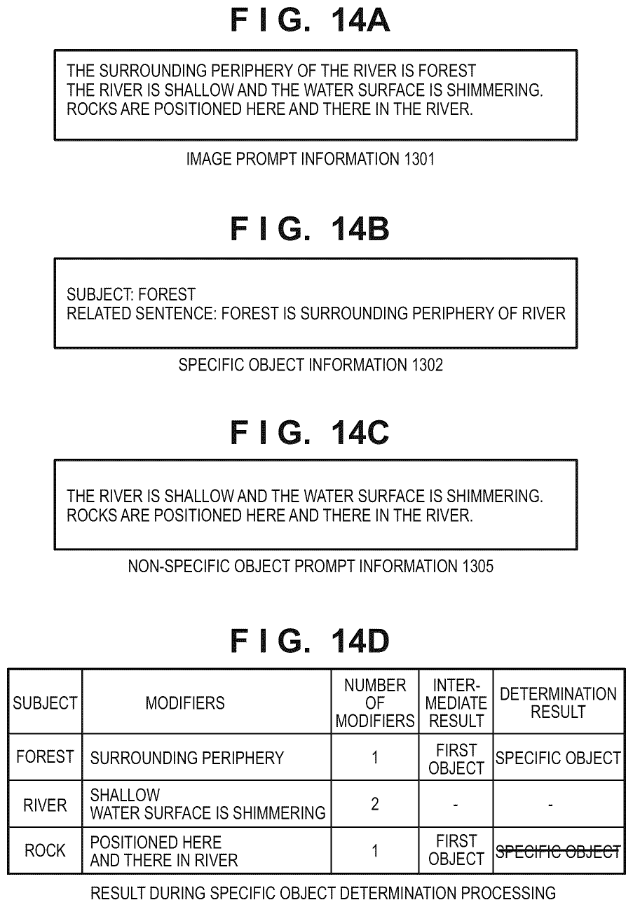

FIG. 12 is a flowchart exemplifying processing of generating a main object image, a specific object image, and non-specific object prompt information from an original image according to the third embodiment. FIG. 13 is a view illustrating a method of generating a main object image, a specific object image, and non-specific object prompt information from an original image according to the third embodiment. FIGS. 14A to 14D are views respectively exemplifying image prompt information, specific object information, non-specific object prompt information, and a result during specific object determination processing according to the third embodiment.

In step S1200, the main object determination unit 1112 reads out an original image 1300 from the nonvolatile memory 103, determines a main object in the original image 1300, and separates the original image into a main object image 1309 and a background image 1308. The main object determination unit 1112 stores the main object image 1309 in the nonvolatile memory 103, and stores the background image 1308 in the volatile memory 104, and the process advances to step S1201.

In step S1201, the image prompt generation unit 106 generates image prompt information 1301 in which features of objects included in the background image 1308 are described in text data, by inference processing using a learned model by receiving the background image 1308 as an input, and the process advances to step S1202. FIG. 14A shows the image prompt information 1301 according to the present embodiment.

In step S1202, the specific object determination unit 107 extracts subjects as a plurality of pieces of object information and modifiers from the image prompt information 1301, determines, for each subject, in accordance with the contents of the modifiers, the number of modifiers, a first character string table 906, and a second character string table 907, whether the subject is a specific object, and outputs specific object information 1302 of the determined specific object. FIG. 14B shows the specific object information 1302 according to the present embodiment. The first character string table 906 and the second character string table 907 are the same as in the second embodiment.

In step S1203, the specific object region extraction unit 108 extracts a specific object image region 1303 as a region of the specific object from the background image 1308, and the process advances to step S1204. FIG. 13 shows, by thick lines, the specific object image region 1303 of “forest” as the specific object of the present embodiment.

In step S1204, the specific object image generation unit 109 performs transparency processing for a region other than the specific object image region 1303 in the background image 1308, generates a specific object image 1304 while leaving only image information of the specific object image region 1303, and stores it in the nonvolatile memory 103, and the process advances to step S1205.

In step S1205, the non-specific object image generation unit 1113 performs transparency processing for the specific object image region 1303 in the background image 1308, and generates a non-specific object image 1310 having the same size as that of the original image while leaving only image information of a region other than the specific object image region 1303.

In step S1206, the non-specific object prompt generation unit 110 generates non-specific object prompt information 1305 in which features of objects included in the non-specific object image 1310 are described in text data, by inference processing using a learned model by receiving the non-specific object image 1310 as an input, and the processing ends. FIG. 14C shows the non-specific object prompt information 1305 according to the present embodiment.

Next, the processing of outputting, by the specific object determination unit 107, the specific object information 1302 from the image prompt information 1301 will be described with reference to FIG. 14D. The processing of the specific object determination unit 107 is the same as in the second embodiment.

The specific object determination unit 107 extracts subjects “forest”, “river”, and “rock” from the image prompt information 1301, and extracts the contents of modifiers and the number of modifiers for each subject, as shown in FIG. 14D.

The subject “forest” is determined as a first object since the number of modifiers is one which is equal to or smaller than a predetermined number, and is determined as the specific object since the subject does not match any character string in the second character string table 907. The subject is determined as neither a second object nor a third object since conditions are not satisfied.

The subject “river” is determined as none of the first to third objects since the number of modifiers is two which exceeds the predetermined number, there is no information with which the contents of a person face can be recognized, and the subject does not match any character string in the first character string table 906.

The subject “rock” is determined as the first object since the number of modifiers is one which is equal to or smaller than the predetermined number, and is not determined as the specific object since the subject matches a character string in the second character string table 907. The subject is determined as neither the second object nor the third object since conditions are not satisfied.

Since there is no subject determined as the second object, the specific object information 1302 which is the specific object information of only “forest” is output, and the processing ends.

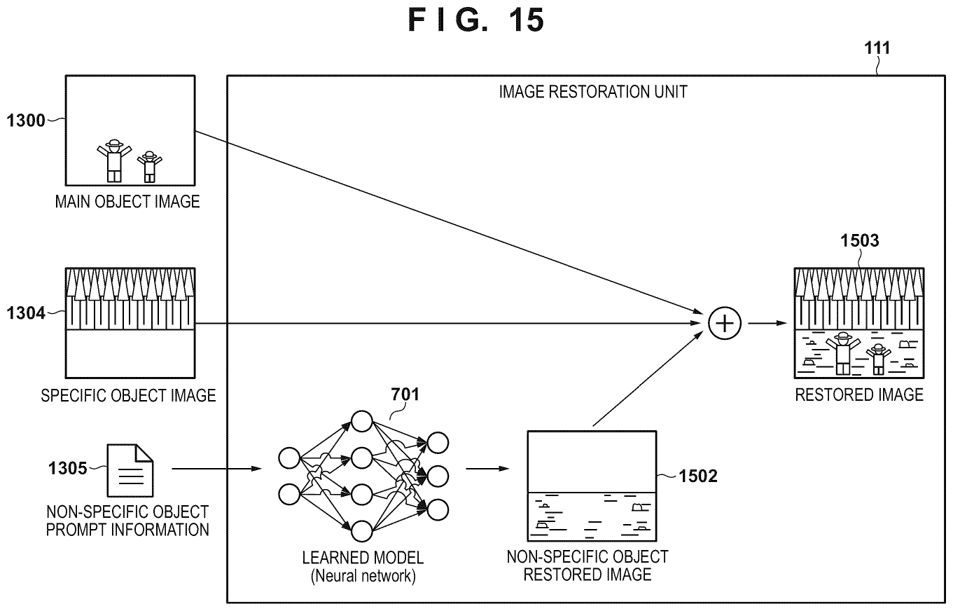

A method of restoring an image from the main object image 1309, the specific object image 1304, and the non-specific object prompt information 1305 according to the third embodiment will be described next with reference to FIG. 15.

The image restoration unit 111 generates a non-specific object restored image 1502 having the same size as that of the original image 1300 by inference processing using a learned model 701 by receiving the non-specific object prompt information 1305 as an input. The restored image generation method is as described in the first embodiment. Next, the image restoration unit 111 generates a restored image 1503 by compositing the specific object image 1304 and the non-specific object restored image 1502 with the main object image 1309.

As described above, according to the third embodiment, while maintaining details of a main object by separating an original image into a main object image and a background image, a specific object is determined in accordance with the contents of prompt information of the background image, the specific object is stored as an image intact, and a prompt is generated for an image of an object other than the specific object, thereby making it possible to improve the reproducibility of the image while reducing the data amount of the image.

In addition, by designating, by a list, simple objects that can be reproduced easily, and generating a prompt without storing an image, it is possible to maintain the reproducibility of an image without increasing a data amount.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-020245, filed Feb. 10, 2025 which is hereby incorporated by reference herein in its entirety.

What is claimed is:

1. An image processing apparatus comprising:
a first prompt generation unit that generates first prompt information in which a feature of an original image is described in text data;
a specific object determination unit that determines a specific object from the original image based on the first prompt information;
a first image generation unit that generates an image of the specific object from the original image; and
a second prompt generation unit that generates second prompt information in which a feature of an image of a non-specific object acquired by excluding a region of the specific object from the original image is described in text data.

2. The apparatus according to claim 1, further comprising an extraction unit that extracts the region of the specific object from the original image,
wherein the first image generation unit generates the image of the specific object while leaving the region of the specific object extracted from the original image by the extraction unit.

3. The apparatus according to claim 1, wherein the specific object determination unit determines the specific object based on features of a plurality of objects included in the first prompt information.

4. The apparatus according to claim 3, wherein the specific object determination unit extracts subjects and modifiers from the first prompt information, and determines, as the specific object, an object indicated by a subject for which the number of modifiers is not larger than a predetermined number.

5. The apparatus according to claim 1, further comprising:
a recording unit that records the image of the specific object and the second prompt information; and
an image restoration unit that generates an image restored from the original image by compositing the image of the specific object and the image of the non-specific object generated from the second prompt information.

6. The apparatus according to claim 5, wherein the image restoration unit restores the image of the non-specific object by inference processing using a learned model by receiving the second prompt information as an input.

7. The apparatus according to claim 1, wherein the specific object determination unit extracts subjects as objects and modifiers for explaining each object from the first prompt information, and determines, for each subject, based on contents of the modifiers, the number of modifiers, a first character string table, and a second character string table, whether the subject is the specific object.

8. The apparatus according to claim 7, wherein the first character string table is a list for designating objects to be stored as images, and the second character string table is a list of objects with high reproducibility when generating images.

9. The apparatus according to claim 8, wherein
the specific object determination unit determines, as a first object, an object indicated by a subject for which the number of modifiers is not larger than a predetermined number, and
in a case where the first object does not match any character string in the second character string table, the object is determined as the specific object.

10. The apparatus according to claim 8, wherein the specific object determination unit determines, as the specific object, an object indicated by a subject for which the modifier indicates a person face and the number of modifiers is not smaller than a predetermined number.

11. The apparatus according to claim 8, wherein in a case where the subject matches a character string in the first character string table, the specific object determination unit determines, as the specific object, an object indicated by the subject.

12. The apparatus according to claim 8, wherein in a case where the specific object determination unit determines, as the specific object, a first object indicated by a subject for which the number of modifiers is not larger than a predetermined number, and determines, as the specific object, a second object indicated by a subject for which the modifier indicates a person face and the number of modifiers is not smaller than the predetermined number, a result of determining the first object as the specific object is invalidated.

13. The apparatus according to claim 1, further comprising a main object determination unit that generates a main object image and a background image from the original image,
wherein the first prompt generation unit generates the first prompt information from the background image.

14. The apparatus according to claim 13, further comprising an extraction unit that extracts a region of the specific object from the background image,
wherein the first image generation unit generates the image of the specific object while leaving only the region of the specific object extracted from the background image by the extraction unit.

15. The apparatus according to claim 14, further comprising a second image generation unit that generates an image of a non-specific object by excluding the region of the specific object extracted from the background image by the extraction unit,
wherein the second prompt generation unit generates the second prompt information from the image of the non-specific object.

16. The apparatus according to claim 15, further comprising:
a recording unit that records the image of the main object, the image of the specific object, and the second prompt information; and
an image restoration unit that generates an image restored from the original image by compositing the image of the main object, the image of the specific object, and the image of the non-specific object generated from the second prompt information.

17. The apparatus according to claim 16, wherein the image restoration unit restores the image of the non-specific object by inference processing using a learned model by receiving the second prompt information as an input.

18. An image processing method executed by an image processing apparatus comprising:
generating first prompt information in which a feature of an original image is described in text data;
determining a specific object from the original image based on the first prompt information;
generating an image of the specific object from the original image; and
generating second prompt information in which a feature of an image of a non-specific object acquired by excluding a region of the specific object from the original image is described in text data.

19. A non-transitory computer-readable storage medium storing a program for causing a computer to function as an image processing apparatus comprising:
a first prompt generation unit that generates first prompt information in which a feature of an original image is described in text data;
a specific object determination unit that determines a specific object from the original image based on the first prompt information;
a first image generation unit that generates an image of the specific object from the original image; and
a second prompt generation unit that generates second prompt information in which a feature of an image of a non-specific object acquired by excluding a region of the specific object from the original image is described in text data.
